(19) United States
(12) Patent Application Publication
(10) Pub. No.: US 2025/0062351 A1
(43) Pub. Date: Feb. 20, 2025

(54) NEGATIVE ELECTRODE ACTIVE MATERIAL PRECURSOR, NEGATIVE ELECTRODE ACTIVE MATERIAL COMPRISING SAME, METHOD FOR PREPARING SAME, AND LITHIUM SECONDARY BATTERY COMPRISING SAME

(71) Applicants: POSCO HOLDINGS INC., Seoul (KR); RESEARCH INSTITUTE OF INDUSTRIAL SCIENCE & TECHNOLOGY, Pohang-si, Gyeongsangbuk-do (KR)

(72) Inventors: Gang Ho LEE, Pohang-si (KR); Sei Min PARK, Pohang-si (KR); Jong Hoon YOON, Pohang-si (KR); Yong Jung KIM, Pohang-si (KR); Jang-Yul KIM, Pohang-si (KR)

(73) Assignees: POSCO HOLDINGS INC., Seoul (KR); RESEARCH INSTITUTE OF INDUSTRIAL SCIENCE & TECHNOLOGY, Pohang-si, Gyeongsangbuk-do (KR)

(21) Appl. No.: 18/720,907

(22) PCT Filed: Dec. 13, 2022
(86) PCT No.: PCT/KR2022/020273

§ 371 Date: Jun. 17, 2024

(30) Foreign Application Priority Data
Dec. 16, 2021 (KR) 10-2021-0180564

(51) Int. Cl. H01M 4/587; C01B 32/21; H01M 4/02; H01M 10/0525

(52) U.S. Cl. CPC H01M 4/587; C01B 32/21; H01M 10/0525; C01P 2004/32; C01P 2004/61; C01P 2006/12; C01P 2006/40; C01P 2006/80; H01M 2004/021; H01M 2004/027

(57) ABSTRACT

The present exemplary embodiment relates to a negative active material precursor and its manufacturing method. According to an exemplary embodiment, it is disclosed a negative active material precursor, comprising:
a stacked portion disposed at a center of the negative active material precursor and where graphite particles are stacked; and at least one of void portion disposed between the center and a surface portion of the negative active material precursor, wherein, an average particle diameter D50 is 10 to 18 μm, and the below equation 1 is satisfied.

$$( D 90 - D 10 ) / D 50 \leq 1. \qquad 〈 Equation 1 〉$$

(In equation 1, D10, D50, and D90 mean particle diameters corresponding to 10, 50, and 90% volume accumulation from a small size, respectively.)

### FIELD OF THE INVENTION

The present exemplary embodiments relate to secondary batteries. More particularly, the present disclosure relates to a negative active material precursor, a manufacturing method thereof, a negative active material including the same, and a lithium secondary battery including the same.

### DESCRIPTION OF THE RELATED ART

A lithium secondary battery generally consists of a positive electrode containing a positive active material, a negative electrode containing a negative active material, a separator, and an electrolyte, and charging and discharge are performed by intercalation-deintercalation of lithium ions. The lithium secondary battery has high energy density, large electric power, and has the merit of high-capacity, so it is applied in various fields.

In addition, improving high temperature performance, such as capacity characteristics at a high temperature and high temperature cycle characteristic, is an important problem in lithium secondary battery. For example, after applying the negative active material to the current collector and rolling it, if the total internal pore volume is high, there is a high possibility that the high temperature performance of the negative electrode will be deteriorated. Therefore, it is necessary to improve the high temperature characteristic when developing negative electrode materials for lithium secondary batteries, for example, for rapid charging, by minimizing changes in electrode structure and total internal pore volume that occur during electrode rolling.

In addition, as technology development and demand for mobile devices increase, the demand for secondary battery as an energy source is rapidly increasing. Among secondary batteries, lithium secondary batteries, which exhibit high energy density and operating potential, long cycle life, and low self-discharge rate, have been commercialized and are widely used.

In addition, as interest in environmental issues grows, interest in electric vehicles and hybrid electric vehicles that can replace vehicles using fossil fuels such as gasoline vehicles and diesel vehicles, which are one of the key causative agents of air pollution, is increasing. Research is actively underway to use lithium secondary batteries as a power source for the electric vehicle and the hybrid electric vehicle.

Recently, due to the rapid rise of EV electric vehicles, expectations for the lithium secondary battery are growing, and demands for preserving existing capacity and improving rapid charge characteristics are increasing. To improve the rapid charge, the role of negative active material, which is responsible for storing lithium ions during charge, is becoming important.

As the negative active material, materials such as metal lithium negative active material, carbon-based negative active material, or silicon oxide (SiOₓ) are used. The carbon-based negative active material exhibits excellent capacity retention characteristics and efficiency. Since the graphite/carbon-based negative electrode active material used as the negative electrode of the lithium secondary battery has a potential close to the electrode potential of lithium metal, the change in crystal structure during the intercalation and deintercalation of ionic lithium is small, enabling a continuous and repeated oxidation reduction reaction at the electrode, providing the basis for the lithium secondary battery to exhibit high capacity and excellent cycle-life.

Various types of materials are used as carbon-based negative electrode active materials, such as natural graphite and artificial graphite, which are crystalline carbon-based materials, or hard carbon and soft carbon, which are amorphous carbon-based materials. Among them, graphite-based active materials are the most widely used, as they are highly reversible and can improve the cycle-life characteristic of lithium secondary batteries. Since graphite active material has a lower discharge voltage of −0.2 V compared to lithium, a battery with graphite active material can exhibit a discharge voltage as high 3.6V. Therefore, it offers many advantages over lithium secondary batteries in terms of energy density.

An artificial graphite, a crystalline carbon-based material, has a more stable crystal structure than natural graphite because it is made by applying high heat energy of more than 2,700° C. to create the crystal structure of graphite. Even with repeated charging and discharging of lithium ions, the crystal structure changes are small, resulting in a relatively long cycle-life. In general, an artificial graphite-based negative electrode active material has a cycle-life that is two to three times longer than natural graphite. Soft carbon and hard carbon, which are amorphous carbonaceous materials with unstabilized crystal structures, are characterized by smoother entry of lithium ions. Therefore, it can be used in electrodes that require fast charging because it can increase the charge and discharge speed. Considering the cycle-life characteristic and output characteristic of the lithium secondary battery to be used, it is common to use a mixture of the above carbon-based materials in a certain ratio to each other.

In addition, the conventional negative active material precursor has a structure where the inside is all rolled up, for example, a cabbage structure. When the particle becomes large, the load is applied heavily to a specific surface, causing damage to the negative active material precursor structure. In addition, there is a problem in which the adherence between electrodes is deteriorated, causing a detachment phenomenon in which the negative active material is separated from the current collector of the Cu material.

### SUMMARY OF THE INVENTION

The technical object that the present invention aims to solve is to provide a negative active material precursor whose structure is maintained even when a load is applied.

Another technical object that the present invention aims to solve is to provide a negative active material with excellent inter-electrode adherence, including a negative active material precursor with the advantage.

Another technical object that the present invention aims to solve is to provide a lithium secondary battery that contains a negative active material with the advantage and prevents the detachment phenomenon of the current collector.

Another technical object that the present invention aims to solve is to provide a method for manufacturing a negative active material precursor with the advantage.

According to an exemplary embodiment, it is disclosed a negative active material precursor, comprising:
a stacked portion disposed at a center of the negative active material precursor and where graphite particles are stacked; and at least one of void portion disposed between the center and a surface portion of the negative active material precursor, wherein, an average particle diameter D50 is 10 to 18 μm, and the below equation 1 is satisfied.

$$( D 90 - D 10 ) / D 50 \leq 1. \qquad 〈 Equation 1 〉$$

(In equation 1, D10, D50, and D90 mean particle diameters corresponding to 10, 50, and 90% volume accumulation from a small size, respectively.)

In an exemplary embodiment, a length of the void portion may be more than 30% relative to a diameter of the long axis, by reference of middle cross-section. In an exemplary embodiment, the stacked portion may have an area of more than 20% when cutting the negative active material precursor mid-cross-section.

In an exemplary embodiment, the negative active material precursor may have a specific surface area of 4 to 8 m²/g. In an exemplary embodiment, the negative active material precursor may have a spherical shape degree of 0.71 or higher.

According to another exemplary embodiment, it is disclosed a lithium secondary battery comprising a negative active material precursor comprising:
a stacked portion disposed at a center of the negative active material precursor and where graphite particles are stacked; and at least one of void portion disposed between the center and a surface portion of the negative active material precursor, wherein, an average particle diameter D50 is 10 to 18 μm, and the below equation 1 is satisfied.

$$( D 90 - D 10 ) / D 50 \leq 1. \qquad 〈 Equation 1 〉$$

(In equation 1, D10, D50, and D90 mean particle diameters corresponding to 10, 50, and 90% volume accumulation from a small size, respectively.)

In an exemplary embodiment, a length of the void portion may be more than 30% relative to a diameter of the long axis, by reference of middle cross-section.

According to another exemplary embodiment of the present invention, it is disclosed a manufacturing method of a negative active material precursor, comprising:
controlling a purity of a graphite material; pulverizing the graphite material; and shaping the pulverized graphite material into a spherical shape,
wherein, the step of shaping the spherical shape includes applying an external force so that at least a portion of a carbon mesh of the graphite material is rolled, in the step of pulverizing the graphite material, an average particle diameter D50 is 10 to 18 μm, and the below equation 1 is satisfied.

In an exemplary embodiment, after the step of pulverizing the graphite material, a step of controlling the particle size of the pulverized graphite material may be further included. In an exemplary embodiment, the step of controlling the purity of the graphite material may be to adjust the purity of the graphite material to 90% or more.

In an exemplary embodiment, the pulverizing step can be performed by at least one of physical impact and airflow impact. In an exemplary embodiment, the step of shaping the pulverized graphite material into a spherical shape, may be performed by: at least one of an airflow method, an assemble spherical shaping method, and a mechanical milling method.

According to an exemplary embodiment, by simultaneously including a stacked portion and a void portion, a negative active material precursor can be utilized to fabricate a high discharge capacity negative electrode material derived from natural graphite.

Additionally, according to another exemplary embodiment, a negative active material including a negative active material precursor having the advantage may be provided.

Additionally, according to another exemplary embodiment of the present invention, a manufacturing method of a negative active material precursor having the advantage may be provided.

Another technical object that the present invention aims to solve is to provide a method for manufacturing a negative active material precursor with the advantage.

### BRIEF DESCRIPTION OF THE DRAWINGS

FIG. 1A and FIG. 1B shows a tissue photograph of a negative active material precursor, according to an exemplary embodiment.

FIG. 2 is a flowchart of the manufacturing method of a negative active material precursor according to an exemplary embodiment.

### DETAILED DESCRIPTION OF THE EMBODIMENTS

Terms such as first, second and third are used to describe, but are not limited to, the various parts, components, region, layers and/or sections. These terms are used only to distinguish one part, component, region, layer, or section from another part, component, area, layer, or section. Accordingly, a first part, component, region, layer or section described herein may be referred to as a second part, component, region, layer or section without departing from the scope of the present invention.

The technical terms used herein are intended to refer only to certain exemplary embodiments and are not intended to limit the present invention. The singular forms used here include plural forms unless the context clearly indicates the opposite. The meaning of “comprising/including/containing/having” as used in a specification is to specify a particular characteristic, region, integer, step, behavior, element, and/or component, and does not exclude the existence or added any other characteristic, region, integer, step, behavior, element, and/or component.

When we say that a part is “on” or “above” another part, it may be directly on or above the other part, or it may entail another part in between. In contrast, when we say that something is “directly on” of something else, we don't interpose anything between them.

Unless otherwise defined, all terms used herein, including technical and scientific terms, have the same meaning as commonly understood by a person of ordinary skill in the technical field to which the present invention belongs. Commonly used dictionary-defined terms are further construed to have meanings consistent with the relevant technical literature and the present disclosure, and are not to be construed in an idealized or highly formal sense unless defined.

Hereinafter, an exemplary embodiment will be described in detail. However, this is presented as an example, and the present invention is not limited thereby, and the present invention is only defined by the category of the claim range, which will be described later.

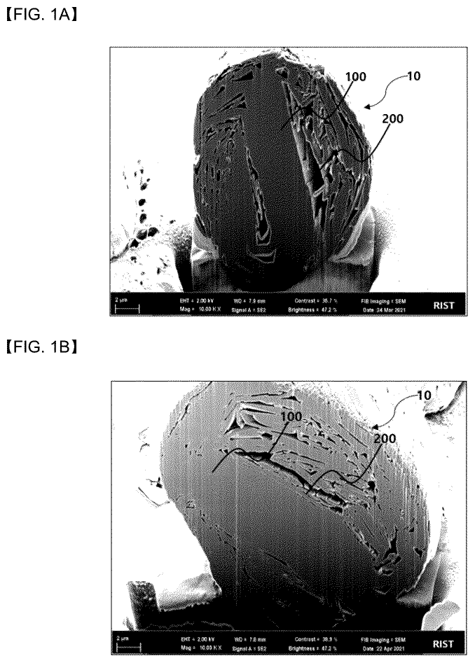

FIG. 1A and FIG. 1B shows a negative active material precursor according to an exemplary embodiment.

Referring to FIG. 1A and FIG. 1B, the negative active material precursor 10 of the present invention may include a stacked portion 100 and a void portion 200. In an exemplary embodiment, the negative active material precursor may be a carbon-based material. The carbon-based material may be at least one of the following materials composed of amorphous carbon, such as artificial graphite, natural graphite, graphitized carbon fiber, graphitized meso-carbon microbeads, petroleum coke, resin-sintering material, carbon-fiber, and thermal decomposition carbon, preferably may be natural graphite. In an exemplary embodiment, the natural graphite may be of various shapes such as flaky, spherical, and blocky, for example, flaky graphite.

The stacked portion 100 is a stack of the carbon-based material and may be disposed in at least a portion of the negative active material precursor 10. The stacked portion 100 refers to a region in which carbon mesh sheets are stacked rather than spherical shaped during spherical shaping work. For example, it means a region in which carbon mesh sheets are stacked rather than rolled. The stacked region is a part that contributes to actual capacity when manufacturing electrodes.

For example, in the stacked portion 100, the carbon-based material may be stacked to penetrate the center, for example, middle region of the negative active material precursor 10. In the stacked portion 100, the carbon-based material may be stacked to penetrate a point off the center of the negative active material precursor.

In an exemplary embodiment, the stacked portion 100 may have an area of 20% or more when cutting the negative active material precursor 100 in the middle cross-section. Specifically, in the cross-section of the stacked portion 100 when the negative active material precursor 100 is cut with the midpoint as a reference, the area occupied by the stacked portion 100 of the entire area may be 20% or more. Since the middle cross-section area of the stacked portion 100 satisfies the range, the carbon mesh sheets are stacked without being rolled, which has the advantage of contributing to practical capacity when manufacturing electrodes. Since the middle cross-section area of the stacked portion 100 does not satisfy the range, there is a problem that it is difficult to realize the effect due to the advantage.

In an exemplary embodiment, the carbon-based material may be, for example, a graphite mesh, and the graphite mesh may be, for example, a hexagonal mesh. The carbon-based material can have a stacking structure formed by layering.

In an exemplary embodiment, the stacking structure may be stacked as an irregular stacking structure, a regular stacking structure, or a combination thereof, as a non-limiting example. By having the irregular stacking structure, the negative active material precursor can easily intercalate and deintercalate lithium ions. Due to the deintercalation of lithium ions, it is possible to absorb stress that occurs due to structural changes such as expansion and contraction and phase changes in in-plane arrangement. This can have excellent advantages in terms of durability. By including a stacking structure with the regularity, there is an advantage in securing excellent capacity density.

At least one void portion 200 may be disposed between the stacked portion 100 and the surface portion of the negative active material precursor 10. The void portion 200 may be an internal void formed when the stacked portion 100 is rolled up. The void portion 200 may be a gap of carbon-based materials within a cabbage shape, for example, a shape that is rolled in from the stacked portion 100 toward the surface portion of the negative active material precursor 10.

The void portion 200 may have a long-slit shape as a non-limiting example. The void portion 200 can effectively buffer the volume expansion of the negative active material precursor 10 that occurs during charge and discharge. The negative active material prepared from negative active material precursor 10 is structurally stable and has no deteriorated lithium storage capacity. Charge and discharge capacity and life-span can be improved. Additionally, void portion 200 has the advantage of reducing the external specific surface area.

In an exemplary embodiment, a length of the void portion may be more than 30% relative to a diameter of the long axis, by reference of middle cross-section. Specifically, void portion 200 may be a gap whose length is 30% or more compared to the diameter of the long axis in cross-section when the midpoint of negative active material precursor 10 is cut.

In an exemplary embodiment, negative active material precursor 100 may have a specific surface area of 4 to 8 m²/g. By satisfying the range, there is an advantage in that electrode adherence is excellent by preventing the problem of electrode adherence being deteriorated during electrode manufacturing.

In an exemplary embodiment, negative active material precursor 100 may have a spherical shape degree of 0.71 or higher. If the spherical shape degree is lower than the range, it is likely to provide a non-reactivity site. Accordingly, the spherical shape degree can be adjusted to 0.71 or higher.

In an exemplary embodiment, a negative active material precursor 100 may have an average particle diameter D50 of 10 to 18 μm. The average particle diameter D50 may be a particle diameter equivalent to 50% of the volume accumulation from the small size. If the average particle diameter D50 of the negative active material precursor 100 is outside the lower limit of the range, the negative active material precursor 100 corresponds to fine particles, and there is a problem in which capacity and efficiency are deteriorated. If it exceeds the upper limit of the range, there is a problem in which efficiency is deteriorated as the discharge capacity decreases.

In an exemplary embodiment, negative active material precursor 100 may satisfy Equation 1 below.

$$( D 90 - D 10 ) / D 50 \leq 1. \qquad 〈 Equation 1 〉$$

(In equation 1, D10, D50, and D90 mean particle diameters corresponding to 10, 50, and 90% volume accumulation from a small size, respectively.)

A negative active material precursor 100 has the advantage of excellent electrode adherence and processability of electrode by satisfying the range of Equation 1. If it is outside the range of Equation 1, the specific surface area increases, and accordingly, there is a problem of electrode adherence being deteriorated.

According to another exemplary embodiment, the negative active material may include a negative active material precursor 100 and a coating layer composed of a coating material on the negative active material precursor 100. A negative active material precursor 100 is the same in the range that does not contradict as described in FIG. 1. The coating layer may be a commonly used material.

The coating layer may include, as a non-limiting example, amorphous carbon. In an exemplary embodiment, the coating layer may include at least one selected from the group consisting of soft carbon and hard carbon. In an exemplary embodiment, the soft carbon may be the carbonization of at least one carbonaceous material selected from polyvinylalcohol, polyvinylchloride, coal-based pitch, petroleum-based pitch, mesophase pitch, and low molecular weight heavy oil. In an exemplary embodiment, the hard carbon may be the carbonization of at least one carbonaceous material selected from sucrose, phenol resin, furan resin, furfuryl alcohol, polyacrylonitrile, polyimide, epoxy resin, cellulose, styrene, citric acid, stearic acid, polyvinylidene fluoride, carboxylmethylcellulose (CMC), hydroxypropylcellulose, polyvinylpyrrolidone, tetrafluoroethylene, polyethylene, glucose, gelatin, saccharide, polypropylene, ethylene propylene diene monomer (EPDM), sulfonated ethylene propylene diene monomer (EPDM).

The coating layer can facilitate the entry and exit of lithium ions or lower the diffusion resistance of lithium ions, contributing to rapid charge performance improvement. The coating layer is disposed on the negative active material precursor surface, thereby improving the hardness of the negative active material including the coating layer. It can improve the structural stability of the negative active material and minimize structural changes during rolling.

According to another exemplary embodiment of the present invention, a lithium secondary battery includes a negative active material including the negative active material precursor 10 described above.

In an exemplary embodiment, the lithium secondary battery has a positive electrode containing a positive active material capable of intercalation and deintercalation of lithium ions. In addition, a negative electrode containing the negative active material manufactured from the negative active material precursor 10 described above is provided. In addition, an electrolyte is additionally provided, and the battery type may be a lithium secondary battery such as a lithium ion battery, lithium ion polymer battery, or lithium polymer battery.

In an exemplary embodiment, the lithium secondary battery may further include a separator disposed between the positive electrode and the negative electrode. A composition for forming a negative active material layer is prepared by mixing the negative active material prepared from the above-described negative active material precursor 10, binder, and selectively conductive material. Then this can be applied to the negative electrode current collector to manufacture the lithium secondary battery. The negative electrode current collector may be, for example, copper foil, nickel foil, stainless steel foil, titanium foil, nickel foam, copper foam, a polymer substrate coated with a conductive metal, or a combination thereof.

The binder may be mixed in an amount of 1 to 30 wt % based on the total amount of the composition for forming a negative electrode active material layer. Examples of the binder may include polyvinyl alcohol, carboxymethylcellulose/styrene-butadiene rubber, hydroxypropylene cellulose, diacetylene cellulose, polyvinyl chloride, polyvinylpyrrolidone, polytetrafluoroethylene, polyvinylidene fluoride, polyethylene, polypropylene, or the like, but are not limited thereto.

The binder may be mixed in an amount of 1 to 30 wt % based on the total amount of the composition for forming a negative electrode active material layer. The conductive material is not particularly limited as long as it has conductivity without causing a chemical change in a battery, and specifically, graphite such as natural graphite and artificial graphite; carbon black such as acetylene black, Ketjen black, channel black, furnace black, lamp black, and summer black; a conductive fiber such as a carbon fiber and a metal fiber; metal powders such as carbon fluoride, aluminum, and nickel powders; conductive whiskeys such as zinc oxide and potassium titanate; a conductive metal oxide such as titanium oxide; a conductive material such as a polyphenylene derivative, or the like, may be used as the conductive material.

The lithium secondary battery manufactured from the negative active material precursor 10 described above has an excellent buffering effect against volume changes that occur during charge and discharge. By including a negative active material with excellent electrical conductivity, it can have high charge and discharge capacity characteristics and excellent cycle characteristics.

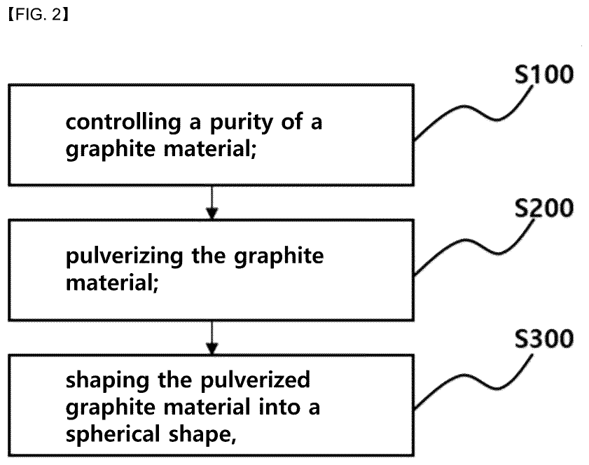

FIG. 2 is a flowchart of the manufacturing method of a negative active material precursor according to an exemplary embodiment.

Referring to FIG. 2, according to another exemplary embodiment of the present invention, the manufacturing method of negative active material precursor 100 includes a step S100 of controlling a purity of a graphite material, a step S200 of pulverizing the graphite material, and a step S300 of shaping the pulverized graphite material into a spherical shape. The graphite material is shown in FIG. 1 can refer to the carbon-based materials mentioned above in a consistent range. Specifically, the graphite material may be, for example, natural graphite in flakes. In addition, the characteristics of negative active material precursor 100 manufactured by the manufacturing method can be referred to FIG. 1.

The step S100 of controlling the purity of the graphite material is the step of adjusting the purity of the graphite material to 90% or more. In an exemplary embodiment, step S100 of controlling the purity of the graphite material may control the purity using the difference in specific gravity. The specific gravity is the value of dividing the density of the solid by the density of water, and as a method using the difference in specific gravity, for example, Archimedes' principle can be used. The Archimedes' principle is a method of checking the specific gravity of the graphite material by comparing the mass of the graphite material outside the water and the mass inside the water. The purity of the graphite material can be controlled by the method. This is a non-limiting example, and various types of methods for measuring specific gravity can be used.

In an exemplary embodiment, if the purity of the graphite material is lower than 90%, it will contain foreign substances other than carbon, such as ash or ash. Specifically, by including foreign substances such as Si, Al, and S, there is a problem of the capacity of the battery being deteriorated and the resulting efficiency being deteriorated during battery manufacturing. Accordingly, by controlling the purity of the graphite material to over 90%, there is an advantage in improving capacity and efficiency when manufacturing batteries.

Step S200 of pulverizing the graphite material may include applying an external force to crush the graphite material or crush it into powder. In an exemplary embodiment, the pulverizing step S200 may pulverize the graphite material by at least one of physical impact and airflow impact. The physical impact may be performed by at least one of, but is not limited to, an Air Classified Mill, Raymond Mill, Vertical Roller Mill, Jaw Crusher, Ball Mill, Agitated Ball Mill, Hammer, and a pin mill. The airflow impact may be performed by a jet mill, as a non-limiting example.

In an exemplary embodiment, step S200 of pulverizing the graphite material may further include adjusting the particle size of the graphite material. The step of controlling the particle size can be separated by at least one of the particle size separation method, specific gravity difference separation method, and magnetic separation method. The particle size separation method is to separate particles according to their size or diameter, and may include various methods of separation, for example, using a sieve. The specific gravity difference separation method is a method of separating particles by considering the difference in specific gravity of each material. For example, by using a specific solvent, particles can be separated using the large or small specific gravity of the particles corresponding to the specific solvent as a reference. Various types of specific gravity separation methods can be applied. The magnetic separation method utilizes a magnetic material to separate particles through contact with the magnetic material, and various types of magnetic separation methods can be applied.

In an exemplary embodiment, the step of controlling the particle size of the graphite material includes adjusting the average particle diameter D50 to be 10 to 18 μm, and adjusting the graphite material to satisfy Equation 1 below, in the step of pulverizing the graphite material. A detailed description of the average particle diameter and Equation 1 below can be referred to FIG. 1.

$$( D 90 - D 10 ) / D 50 \leq 1. \qquad 〈 Equation 1 〉$$

(In equation 1, D10, D50, and D90 mean particle diameters corresponding to 10, 50, and 90% volume accumulation from a small size, respectively.)

In an exemplary embodiment, the step of controlling the particle size of the graphite material may adjust the particle size of the graphite material to 50 μm or less. If the particle size of the graphite material is larger than 50 μm, two particles are stacked, causing a problem that deviates from the ideal thickness of the active material on the electrode sheet. Additionally, there is a problem that particles of the active material break during pressure molding. Accordingly, the particle size of the pulverized graphite material can be adjusted to 50 μm or less.

In the step S300 of shaping the pulverized graphite material into spherical shape, the filling density can be adjusted to have a high tap density by manufacturing the graphite material into spherical shape particles. The angled part of the graphite material can be shaped into a spherical shape and separated or combined with fine particles. In an exemplary embodiment, the spherical shaping step S300 may be performed by at least one of an airflow method, an assemble spherical shaping method, and a mechanical milling method.

The method using the airflow may be one in which spherical shaping is performed by friction between the wall surface and the negative active material precursor by an airflow using centrifugal force. The assemble spherical shaping method is a method in which grinding and assembling are carried out simultaneously. It may include a dry method in which crushed particles are processed by a milling method such as a blade mill, multi-purpose mixer grinder, or a combination thereof, and a wet method using spray drying. The mechanical milling method is a method in which two or more rollers rotate by causing friction in the vertical direction, and may be used to shape the negative active material precursor into a spherical shape.

In an exemplary embodiment, the spherical shaping step S300 may include applying an external force so that at least a portion of the carbon mesh surface of the graphite material is rolled. By going through step S300 of forming the spherical shape, not only the stacked portion 100 described above in FIG. 1 but also the void portion 200 can be formed. For example, the graphite material can maintain a curled shape, such as a cabbage shape, with some of the carbon mesh faces through physical surface contact.

In this way, the negative active material precursor 10, which is manufactured through the step of applying an external force so that at least some of the carbon mesh surface of the graphite material is rolled, has a rolled structure to minimize side effects of the surface site. It can have a constant void portion of 200 to maintain a buffering effect during charge and discharge. The middle region of the negative active material precursor 10 may have a stacked portion 100, which is a portion in which a carbon-based material such as a graphite network is stacked. By distinguishing the stacked portion 100 and the void portion 200, the manufacturing method of the above-mentioned negative active material precursor can provide a negative active material precursor 10 with a structure that facilitates the intercalation and deintercalation of lithium particles involved in the capacity of the lithium secondary battery.

Hereinafter, an exemplary embodiment will be described in detail so that a person of an ordinary skill can easily practice it in the technical field to which the present invention belongs. However, the present invention may be implemented in various different forms and is not limited to the exemplary embodiment described herein.

### Exemplary Embodiment 1 and Comparative Example 1

The following Table 1 shows the results of electrode adherence on copper foil based on the electrode manufactured according to the negative active material precursor of Exemplary Embodiment 1 and Comparative Example 1. The exemplary embodiment 1 is an exemplary embodiment of the negative active material precursor 100 structure of the present invention manufactured through FIGS. 1 and 2 described above. The Comparative Example 1, unlike the negative active material precursor 100 of the present invention, does not include a stacked portion 100 and has a conventional cabbage structure.

In the following Table 1, electrode adherence is measured at the time when detachment occurs when drying in a vacuum oven at 100° C. after manufacturing the electrode, and whether detachment occurs up to 12 hours was determined. In the following Table 1, electrode adherence [Hour] of 12 means that detachment did not occur. The detachment refers to the phenomenon in which the negative active material separates from the current collector of the copper foil.

TABLE 1

| | Particle size | | | | | Electrode | |
|---|---|---|---|---|---|---|---|
| | | | | (D90 − | specific | adherence | |
| Division | D10 | D50 | D90 | D10)/D50 | surface area | [Hour] | Adherence [gf] |
| Comparative | 11 | 15 | 24 | 0.87 | 8 | 12 | 870 |
| Example 1 | | | | | | | |
| exemplary | 9 | 14 | 22 | 0.93 | 5 | 12 | 910 |
| embodiment 1 | | | | | | | |

Looking at the Table 1, when comparing the similar particle sizes and (D90−D10)/D50 of Comparative Example 1 and exemplary embodiment 1, you can see that the specific surface area of the exemplary embodiment 1 is smaller. In the case of the Comparative Example 1, unlike exemplary embodiment 1, it can be determined that this is due to excessive curling of the graphite mesh surface. Accordingly, according to exemplary embodiment 1, which is the structure of the present invention, it can be determined that there are few reaction sites such as unnecessary electrolyte solution in that there are few external cracks as well as the internal void portion. Through Comparative Example 1 and exemplary embodiment 1, it can be confirmed that the exemplary embodiment has more excellent electrode adherence.

### Comparative Example 2 and Comparative Example 3

Looking at the following Table 2, Comparative Example 2 and Comparative Example 3, like the aforementioned Comparative Example 1, are conventional negative active material precursors. Unlike the present invention, for the precursor that does not include the stacked portion 100, unlike Comparative Example 1, only the particle size was adjusted and then the specific surface area, electrode adherence, and adherence were confirmed.

TABLE 2

| | Particle size | | | | | Electrode | |
|---|---|---|---|---|---|---|---|
| | | | | (D90 − | specific | adherence | |
| Division | D10 | D50 | D90 | D10)/D50 | surface area | [Hour] | Adherence [gf] |
| exemplary | 9 | 14 | 22 | 0.93 | 5 | 12 | 910 |
| embodiment 1 | | | | | | | |
| Comparative | 10 | 20 | 30 | 1.00 | 7 | 6 | 150 |
| Example 2 | | | | | | | |
| Comparative | 8 | 16 | 28 | 1.25 | 9 | 6 | 180 |
| Example 3 | | | | | | | |

Looking at the Table 2, it can be seen that Comparative Example 2 has a large D50, and accordingly, the electrode adherence result is poor. This can be judged to be due to damage and destruction to the structure of the negative electrode, including the negative active material precursor, because the cabbage structure is all rolled up inside and a specific surface receives a large amount of load. Looking at the Table 2, in Comparative Example 3, since (D90−D10)/D50 is quite large, the specific surface area is increased, and accordingly, it can be seen that the adherence of the electrode is deteriorated. Therefore, the following facts can be found through Comparative Example 1 in Table 1 and Comparative Examples 2 and 3 in Table 2 above. It can be seen that the negative active material precursor structure having simultaneously a stacked portion and a void portion, such as the negative active material precursor of the present invention, has excellent electrode adherence and structural stability. As a result, it can be confirmed that electrode workability is excellent.

### Comparative Example 4 and Comparative Example 5

Looking at the following Table 3, Comparative Example 4 and Comparative Example 5, like exemplary embodiment 1, have a negative active material precursor 100 structure of the present invention manufactured through FIGS. 1 and 2 described above. However, it can be confirmed that the average particle size D50 or (D90−D10)/D50 is outside the range of the present invention, showing inferior effect.

TABLE 3

| | Particle size | | | | | Electrode | |
|---|---|---|---|---|---|---|---|
| | | | | (D90 − | specific | adherence | |
| Division | D10 | D50 | D90 | D10)/D50 | surface area | [Hour] | Adherence [gf] |
| exemplary | 9 | 14 | 22 | 0.93 | 5 | 12 | 910 |
| embodiment 1 | | | | | | | |
| Comparative | 10 | 19 | 24 | 0.74 | 9 | 11 | 210 |
| Example 4 | | | | | | | |
| Comparative | 8 | 15 | 24 | 1.07 | 9 | 8 | 150 |
| Example 5 | | | | | | | |

Looking at Table 3, Comparative Example 4 is judged to have suffered no damage to the structure compared to Comparative Example 2 of Table 2, which has a similar particle size with electrode adherence of 11 hours. Because of this, it can be seen that although it has excellent electrode adherence, the electrode adherence does not meet 12 hours. In conclusion, it can be confirmed that the average particle size D50 has inferior adherence compared to exemplary embodiment 1, which is included in the range of the present invention. Looking at Table 3, it can be seen that Comparative Example 5 has a slight advantage in electrode adherence compared to Comparative Example 3 in Table 2, which has a similar particle size. However, since the value of (D90−D10)/D50 exceeds the range of the present invention, it can be confirmed that the adherence of the electrode is deteriorated due to the high specific surface area.

Likewise, looking at Table 2 and Table 3, we can see the following facts. Like the negative active material precursor of the present invention, it has a stacked portion in the center region of the precursor, and simultaneously includes a void portion formed as the graphite network, which is part of the stacked portion, is partially rolled up between the stacked portion and the surface portion, so that this can provide a negative active material precursor with excellent electrode adherence and excellent electrode workability. In addition, the negative active material precursor satisfies a D50 of 18 μm or less and a (D90−D10)/D50 value of 1.00 or less, so that is can provide a negative active material precursor with more excellent electrode adherence and electrode workability.

### Exemplary Embodiment 1-1, Exemplary Embodiment 1-2, Comparative Example 1-1, and Comparative Example 1-2

Looking at the following Table 4, spherical shaping work was performed on the negative active material precursor of exemplary embodiment 1 and Comparative Example 1 described above. Spherical shaping was performed for 10 minutes at an output of 40% using Hosokawa Micron's mechanofusion and was named exemplary embodiment 1-1 and Comparative Example 1-1. The same process described above, carried out for an additional 10 minutes, was named exemplary embodiment 1-2 and Comparative Example 1-2.

The degree of spherical shape was achieved by dispersing the sample powder in a solvent such as ethanol using FlowCAM PV, then obtaining an optical image through the Flow cell+ objective lens and performing shape analysis using a dedicated algorithm.

In addition, a negative electrode was manufactured in the following manner using the negative active material precursor of Comparative Example 1, Comparative Example 1-1, Comparative Example 1-2, exemplary embodiment 1, exemplary embodiment 1-1, and exemplary embodiment 1-2. Petroleum pitch with a softening point of 250° C. was coated at 2% of the weight of the base material by applying shear force through high-speed rotation. A negative active material was manufactured by heat treating the coated particles at 1,200° C. for about 1 hour.

In addition, the negative active material was manufactured using the negative active material precursor of Comparative Example 1, Comparative Example 1-1, Comparative Example 1-2, exemplary embodiment 1, exemplary embodiment 1-1, and exemplary embodiment 1-2. A negative active material slurry was prepared by mixing 97 wt % of the negative active material, 2 wt % of binder containing carboxy methyl cellulose and styrene butadiene rubber, and 1 wt % of Super P conductive material in distilled water solvent.

The negative active material slurry was applied to the copper (Cu) current collector, dried at 100° C. for 10 minutes, and compressed in a roll press. Afterwards, a negative electrode was prepared by vacuum-drying in a 100° C. vacuum oven for 12 hours. After the vacuum-drying, the electrode density of the negative electrode was set to 1.5 to 1.7 g/cc.

The negative electrode prepared by the method and counter electrode as lithium metal were used. As an electrolyte solution, 1 mole of LiPF₆ solution dissolved in a mixed solvent with a volume ratio of ethylene carbonate (EC, Ethylene Carbonate):dimethyl carbonate (DMC, Dimethyl Carbonate) of 1:1 was used. Using each component, a half-cell of 2030 coin cell type was manufactured according to a typical manufacturing method, and the capacity, initial efficiency, and capacity retention were confirmed. At this time, capacity retention indicates how much capacity is maintained after charging and discharging the battery 50 times.

TABLE 4

| | Particle size | | | | spherical | Electrode | | | Initial | |
|---|---|---|---|---|---|---|---|---|---|---|
| | | | | (D90 − | shape | adherence | Adherence | Capacity | efficiency | Retention |
| Division | D10 | D50 | D90 | D10)/D50 | degree | [Hour] | [gf] | [mAh/g] | [%] | [%] |
| Comparative | 11 | 15 | 24 | 0.87 | 0.73 | 12 | 870 | 355 | 91 | 90 |
| Example 1 | | | | | | | | | | |
| Comparative | 10 | 13 | 21 | 0.85 | 0.82 | 12 | 890 | 358 | 93 | 88 |
| Example | | | | | | | | | | |
| 1-1 | | | | | | | | | | |
| Comparative | 8 | 11 | 20 | 1.09 | 0.70 | 8 | 850 | 310 | 88 | 71 |
| Example | | | | | | | | | | |
| 1-2 | | | | | | | | | | |
| exemplary | 9 | 14 | 22 | 0.93 | 0.75 | 12 | 910 | 358 | 92 | 93 |
| embodiment | | | | | | | | | | |
| 1 | | | | | | | | | | |
| exemplary | 7 | 13 | 19 | 0.92 | 0.91 | 12 | 970 | 360 | 93 | 98 |
| embodiment | | | | | | | | | | |
| 1-1 | | | | | | | | | | |
| exemplary | 6 | 12 | 18 | 1.00 | 0.95 | 12 | 990 | 364 | 92 | 95 |
| embodiment | | | | | | | | | | |
| 1-2 | | | | | | | | | | |

Looking at Table 4, Comparative Example 1-2, which went through spherical shaping twice, actually has a deteriorated degree of spherical shaping. Accordingly, the (D90−D10)/D50 value depending on the particle size increases, confirming that pulverization, rather than spherical shaping, of the particles occurred. Additionally, looking at exemplary embodiments, it can be seen that as the degree of spherical shaping increases, adherence also increases proportionally. Therefore, by having the negative active material precursor structure of the present invention, it can be confirmed that not only is the density excellent, the hardness is high, but also the electrode adherence is excellent. Additionally, by having a structure of a stacked portion in the middle region and a void portion with a rolled shape between the stacked portion and the negative active material precursor surface portion, elastic capacity is created. As a result, it can be confirmed that it is possible to provide a negative active material precursor with flexibility and a robust structure. Additionally, looking at exemplary embodiments, it can be seen that not only are the capacity and efficiency excellent, but the capacity maintenance rate is maintained at a high level even after 50 charges and discharges.

The present invention is not limited to the exemplary embodiments but can be manufactured in a variety of different forms. In the technical field to which the present invention belongs, a person of an ordinary skill can understand that it can be implemented in another specific form without changing the technical idea or essential characteristics of the present invention. Therefore, the exemplary embodiments described above should be understood in all respects as illustrative and not limiting.

What is claimed is:

1. A negative active material precursor, comprising:
a stacked portion disposed at a center of the negative active material precursor and where graphite particles are stacked; and
at least one of void portion disposed between the center and a surface portion of the negative active material precursor,
wherein, an average particle diameter D50 is 10 to 18 μm, and
the below equation 1 is satisfied.
$$( D 90 - D 10 ) / D 50 \leq 1. \qquad 〈 Equation 1 〉$$
(In equation 1, D10, D50, and D90 mean particle diameters corresponding to 10, 50, and 90% volume accumulation from a small size, respectively.)

2. The negative active material precursor of claim 1, wherein:
a length of the void portion is more than 30% relative to a diameter of the long axis, by reference of middle cross-section.

3. The negative active material precursor of claim 1, wherein:
the stacked portion has an area of more than 20% when cutting the negative active material precursor in the middle cross-section.

4. The negative active material precursor of claim 1, has:
a specific surface area of 4 to 8 m²/g.

5. The negative active material precursor of claim 1, has:
a spherical shape degree of 0.71 or higher.

6. A lithium secondary battery comprising a negative active material precursor comprising:
a stacked portion disposed at a center of the negative active material precursor and where graphite particles are stacked; and
at least one of void portion disposed between the center and a surface portion of the negative active material precursor,
wherein, an average particle diameter D50 is 10 to 18 μm, and
the below equation 1 is satisfied.
$$( D 90 - D 10 ) / D 50 \leq 1. \qquad 〈 Equation 1 〉$$
(In equation 1, D10, D50, and D90 mean particle diameters corresponding to 10, 50, and 90% volume accumulation from a small size, respectively.)

7. The lithium secondary battery of claim 6, wherein:
a length of the void portion is more than 30% relative to a diameter of the long axis, by reference of middle cross-section.

8. A manufacturing method of a negative active material precursor, comprising:
controlling a purity of a graphite material;
pulverizing the graphite material; and
shaping the pulverized graphite material into a spherical shape,
wherein, the step of shaping the spherical shape includes applying an external force so that at least a portion of a carbon mesh of the graphite material is rolled,
in the step of pulverizing the graphite material, an average particle diameter D50 is 10 to 18 μm, and
the below equation 1 is satisfied.
$$( D 90 - D 10 ) / D 50 \leq 1. \qquad 〈 Equation 1 〉$$
(In equation 1, D10, D50, and D90 mean particle diameters corresponding to 10, 50, and 90% volume accumulation from a small size, respectively.)

9. The manufacturing method of claim 8, wherein:
after the step of pulverizing the graphite material, a step of controlling the particle size of the pulverized graphite material is further included.

10. The manufacturing method of claim 8, wherein:
the step of controlling the purity of the graphite material is to adjust the purity of the graphite material to 90% or more.

11. The manufacturing method of claim 8, wherein:
the pulverizing step is performed by at least one of physical impact and airflow impact.

12. The manufacturing method of claim 8, wherein:
the step of shaping the pulverized graphite material into a spherical shape, is performed by:
at least one of an airflow method, an assemble spherical shaping method, and a mechanical milling method.
